(19) United States
(12) Patent Application Publication
(10) Pub. No.: US 2025/0272330 A1
(43) Pub. Date: Aug. 28, 2025

(54) METHODS AND SYSTEMS FOR GENERATING AUTOMATED SPORTS SUMMARIES

(71) Applicant: STATS LLC, Chicago, IL (US)

(72) Inventors: Leland AU, Sunnyvale, CA (US); Armani AKINES, Seattle, WA (US); David POMERLEANO, Sunnyvale, CA (US); Ganesh BONALA, Morrisville, NC (US)

(73) Assignee: Stats LLC, Chicago, IL (US)

(21) Appl. No.: 19/060,137

(22) Filed: Feb. 21, 2025

Related U.S. Application Data
(60) Provisional application No. 63/558,919, filed on Feb. 28, 2024.

(51) Int. Cl. G06F 16/34

(52) U.S. Cl. CPC G06F 16/345

(57) ABSTRACT

Disclosed techniques relate to using machine learning for sports applications. In an example, a method for generating textual summaries using one or more generative machine learning models is disclosed. The method can include receiving, from a client device, a request for a summary of a sporting event. The method can include accessing, from a database, one or more database records including sports related data that is associated with the sporting event. The method can include formulating, from the database records, a machine learning model prompt. The method can include providing the machine learning model prompt to the one or more generative machine learning models. The method can include receiving, from the one or more generative machine learning models, a textual summary of the sporting event. The method can include outputting the textual summary to the client device.

### CROSS-REFERENCE TO RELATED APPLICATIONS

This application claims priority under 35 U.S.C. § 119(e) to Provisional U.S. Patent Application No. 63/558,919, filed Feb. 28, 2024, the disclosure of which is hereby incorporated by reference in its entirety.

### FIELD OF THE DISCLOSURE

The present disclosure relates generally to machine learning for sports applications. In particular, the present disclosure relates to various aspects of machine learning techniques for automatically generating summaries of sporting events.

### BACKGROUND

Machine learning techniques can be used to analyze sports data and make predictions. But relying solely on manual commentary for sports programs, or live broadcasts, poses certain challenges and limitations that may impact the timeliness and quality of content.

Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to using machine learning for sports applications. In an aspect, disclosed techniques include a method for generating textual summaries using one or more generative machine learning models. The method can include receiving, from a client device, a request for a summary of a sporting event. The method can include accessing, from a database, one or more database records including sports related data that is associated with the sporting event. The method can include formulating, from the database records, a machine learning model prompt. The machine learning model prompt can include instructions readable by the one or more machine learning models and sports related data from the one or more database records. The method can include providing the machine learning model prompt to the one or more generative machine learning models. The method can include receiving, from the one or more generative machine learning models, a textual summary of the sporting event. The method can include outputting the textual summary to the client device.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 is a block diagram of an exemplary tracking and analytics environment, in accordance with an aspect of the disclosed subject matter.

FIG. 2 is a block diagram illustrating a textual summary prediction environment, in accordance with an aspect of the disclosed subject matter.

FIG. 3 is a block diagram illustrating a data store, in accordance with an aspect of the disclosed subject matter.

FIG. 4 is a flow diagram of an exemplary method for using machine learning models to generate textual summaries of sporting events, in accordance with an aspect of the disclosed subject matter.

FIG. 5 is an exemplary textual preview, in accordance with an aspect of the disclosed subject matter.

FIG. 6 is another exemplary textual summary, in accordance with an aspect of the disclosed subject matter.

FIG. 7 is another exemplary textual report, in accordance with an aspect of the disclosed subject matter.

FIG. 8 is another exemplary textual report, in accordance with an aspect of the disclosed subject matter.

FIG. 9 is another exemplary textual report, in accordance with an aspect of the disclosed subject matter.

FIG. 10 is another exemplary textual report, in accordance with an aspect of the disclosed subject matter.

FIG. 11 depicts a flow diagram for training a machine learning model, in accordance with an aspect of the disclosed subject matter.

FIG. 12 depicts an example of a computing device, in accordance with an aspect of the disclosed subject matter.

Notably, for simplicity and clarity of illustration, certain aspects of the figures depict the general configuration of the various aspects. Descriptions and details of well-known features and techniques may be omitted to avoid unnecessarily obscuring other features. Elements in the figures are not necessarily drawn to scale; the dimensions of some features may be exaggerated relative to other elements to improve understanding of the example aspects.

### DETAILED DESCRIPTION OF ASPECTS

Various aspects of the present disclosure relate to techniques for machine learning for sports applications. For instance, disclosed techniques involve training machine learning models to make predictions of certain events, deploying the appropriate machine learning models, and/or adjusting the machine learning models employed for predictions, as appropriate. In particular, certain aspects relate to using machine learning models to generate textual summaries of sporting events. Examples of textual summaries include game previews, summaries, and live reports.

Game previews can facilitate a basic understanding of a context of a game that has yet to occur. Game summaries provide a more detailed summary of a completed game, including in some cases, headlines and player ratings. Live reports are summaries of an ongoing game, and can include updates on scores, fouls, players, injuries, and so forth.

The following non-limiting example is introduced for discussion purposes. In the example, a system receives a request for a summary of a sporting event and accesses relevant database records from a database. The database records can include sports-related data associated with the sporting event such as player, team, and/or league related information. The system formulates a machine learning prompt from the database records. The prompt can include instructions for the model and/or sports related data from the database records. The system provides the prompt to the model and receives, from the model, a textual summary of the sporting event. The system can output the textual summary to the client device. The textual summary may include one or more of a preview of a future sporting event, a recap of a past sporting event, and/or a live report of an ongoing sporting event

Technical advantages of the disclosed techniques include improvements to machine learning. For instance, certain aspects relate to generating prompts for machine learning models that improve the performance, accuracy, and results of such models. In so doing, disclosed techniques provide improvements relative to existing solutions.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), graph neural network (GNN), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

Further, while various aspects are discussed with respect to soccer (e.g., a predicted total number of passes by a team during a game), such aspects are described are merely illustrative examples. Disclosed techniques are by no means limited to soccer. For example, the present aspects can be implemented for other sports or activities, such as football, basketball, baseball, hockey, cricket, rugby, tennis, team sports, individual sports, and so forth.

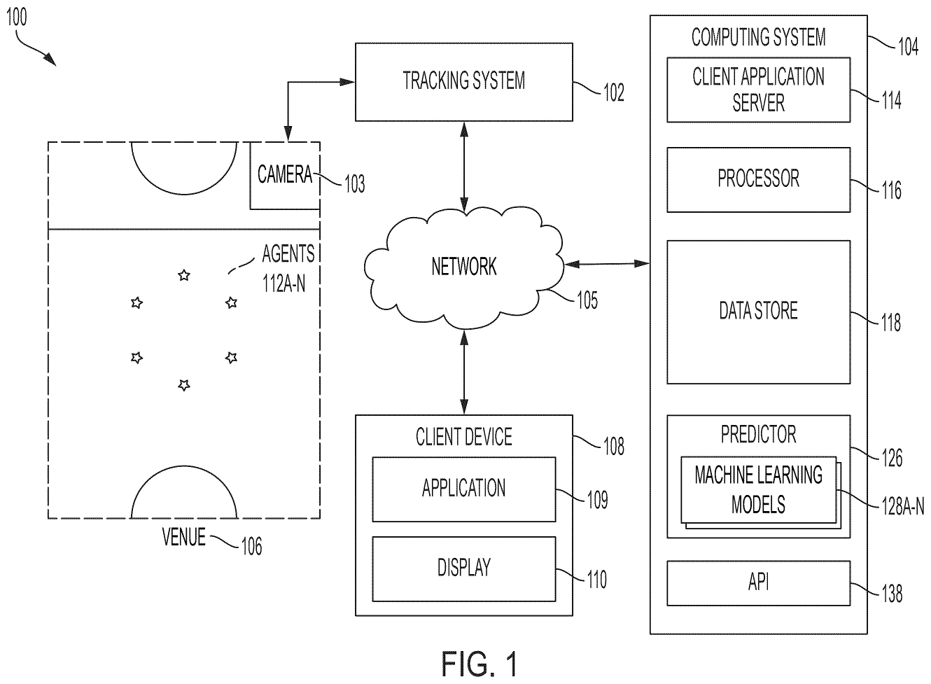

FIG. 1 is a block diagram illustrating a tracking and analytics environment 100, in accordance with an aspect of the disclosed subject matter. Environment 100 includes tracking system 102, computing system 104, and client device 108 connected via network 105. In the example depicted, tracking system 102 obtains various attributes (e.g., measurements, data, information, etc.) of game play, and transmits the attributes across network 105 to computing system 104, where one or more machine learning models are used to generate one or more textual summaries from the measurements of game play. As discussed further herein, computing system 104 can generate textual summaries related to past, ongoing, or future sporting events.

Tracking system 102 is be positioned in, adjacent to, in communication with, or near a venue 106. Non-limiting examples of venue 106 include stadiums, fields, pitches, and courts. Venue 106 includes agents 112A-N (e.g., players). Tracking system 102 may be configured to record the motions and actions of agents 112A-N on the playing surface, as well as one or more other objects of relevance (e.g., ball, referees, etc.). Although environment 100 depicts agents 112A-N generally as players, it will be understood that in accordance with certain implementations, agents 112A-N may correspond to players, objects, markers, and/or the like.

In some aspects, tracking system 102 may be an optically-based system using, for example, camera 103. While one camera is depicted, additional cameras are possible. For example, a system of six stationary, calibrated cameras, which project the three-dimensional locations of players and the ball onto a two-dimensional overhead view of the court may be used.

In some aspects, a mix of stationary and non-stationary cameras may be used to capture motions of all agents 112A-N on the playing surface as well as one or more objects or relevance. Utilization of such tracking system (e.g., tracking system 102) may result in many different camera views of the court (e.g., high sideline view, free-throw line view, huddle view, face-off view, end zone view, etc.). In some aspects, tracking system 102 may be used for a broadcast feed of a given match. In such aspects, each frame of the broadcast feed may be stored in a game file. In some aspects, the game file may further be augmented with other event information corresponding to event data, such as, but not limited to, game event information (pass, made shot, turnover, etc.) and context information (current score, time remaining, etc.).

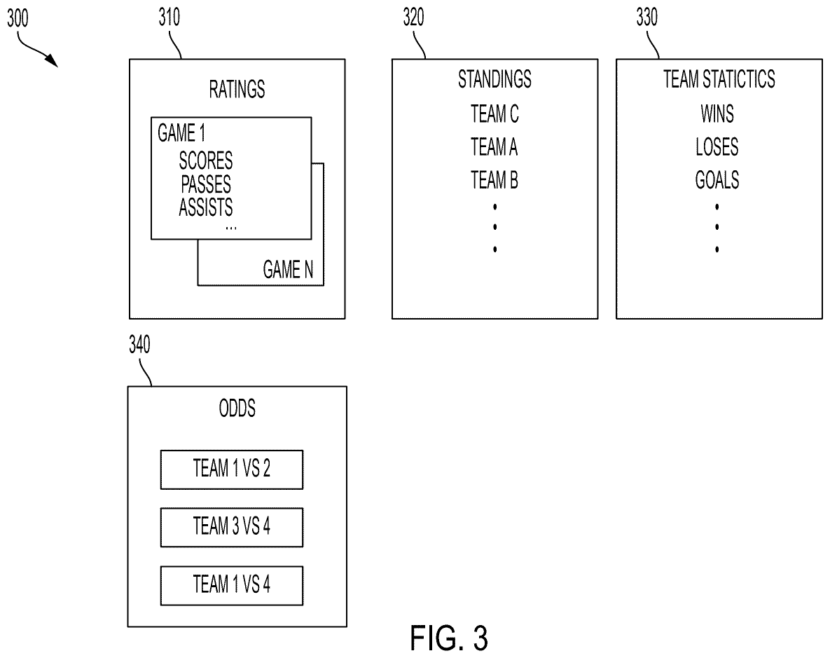

In some aspects, a game file may include ratings data, standings data, statistics, and/or odds, as discussed further with respect to FIG. 3. In some aspects, a game file may include one or more match data types. A match data type may include, but is not limited to, position data (e.g., player position, object position, etc.) change data (e.g., changes in position, changes in players, changes in objects, etc.), trend data (e.g., player trends, position trends, object trends, team trends, etc.), play data, etc. A game file may be a single game file or may be segmented (e.g., grouped by one or more data type, grouped by one or more players, grouped by one or more teams, etc.).

In some embodiments, tracking system 102 may be used for a broadcast feed of a given match. For example, tracking system 102 may be used to generate game files to facilitate a broadcast feed of a given match. In such embodiments, each frame of the broadcast feed may be stored in a game file. A broadcast feed may be a feed that is formatted to be broadcast over one or more channels (e.g., broadcast channels, internet based channels, etc.). A game file may be converted from a first format (e.g., a format output by the one or more cameras or a different format than the format output by the one or more cameras) and may be converted into a second format (e.g., for broadcast transmission).

In some embodiments, game file may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine learning trained to receive, as an input, a game file or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events. The tracking data and/or event data may be used to generate game previews/game summaries as disclosed herein.

Tracking system 102 may be configured to communicate with organization computing system 104 via network 105. For example, tracking system 102 may be configured to provide computing system 104 with a broadcast stream of a game or event in real-time or near real-time via network 105. As an example, tracking system 102 may provide one or more game files in a first format (e.g., corresponding to a format based on the components of tracking system 102). Alternatively, or in addition, tracking system 102 or organization computing system 104 may convert the broadcast stream (e.g., game files) into a second format, from the first format. The second format may be based on the computing system 104. For example, the second format may be a format associated with data store 118, discussed further herein.

Computing system 104 may be configured to process the broadcast stream of the game. Organization computing system 104 may include components shown in FIG. 1, as described herein, as well as one or more of a tracking data system, a play-by-play module, and/or padding module. A tracking data system, play-by-play module, padding module, and prediction system (including predictor 126) may be comprised of one or more software modules. The one or more software modules may be collections of code or instructions stored on a media (e.g., memory of computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

The tracking data system may be configured to receive broadcast data from tracking system 102 and generate tracking data from the broadcast data. In some embodiments, the tracking data system may apply an artificial intelligence and/or computer vision system configured to derive player-tracking data from broadcast video feeds.

To generate the tracking data from the broadcast data, the tracking data system may, for example, map pixels corresponding to each player and ball to dots and may transform the dots to a semantically meaningful event layer, which may be used to describe player attributes. For example, the tracking data system may be configured to ingest broadcast video received from tracking system 102. In some embodiments, the tracking data system may further categorize each frame of the broadcast video into trackable and non-trackable clips. In some embodiments, the tracking data system may further calibrate the moving camera based on the trackable and non-trackable clips. In some embodiments, the tracking data system may further detect players within each frame using skeleton tracking. In some embodiments, the tracking data system may further track and re-identify players over time. For example, the tracking data system may reidentify players who are not within a line of sight of a camera during a given frame. In some embodiments, the tracking data system may further detect and track an object across a plurality of frames. In some embodiments, the tracking data system may further utilize optical character recognition techniques. For example, the tracking data system may utilize optical character recognition techniques to extract score information and time remaining information from a digital scoreboard of each frame.

Such techniques assist in the tracking data system generating tracking data from the broadcast feed (e.g., broadcast video data). For example, the tracking data system may perform such processes to generate tracking data across thousands of possessions and/or broadcast frames. In addition to such process, computing system 104 may go beyond the generation of tracking data from broadcast video data. Instead, to provide descriptive analytics, as well as a useful feature representation for the prediction system, computing system 104 may be configured to map the tracking data to a semantic layer (e.g., events).

The tracking data system may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

A play-by-play module may be configured to receive play-by-play data from one or more third party systems. For example, the play-by-play module may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, the play-by-play module may utilize machine learning outputs and/or manually annotated data that may reflect the referee's ultimate adjudication. Such data may be referred to as the play-by-play feed.

To help identify events within the generated tracking data, the tracking data system may merge or align the play-by-play data with the raw generated tracking data (which may include the game and time fields). The tracking data system may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, the tracking data system may be configured to perform various operations on the aligned tracking system. For example, the tracking data system may use the play-by-play data to refine the player and ball positions and precise frame of the end of possession events (e.g., shot/rebound location). In some embodiments, the tracking data system may further be configured to detect events, automatically, from the tracking data. In some embodiments, the tracking data system may further be configured to enhance the events with contextual information.

For automatic event detection, the tracking data system may include a neural network system trained to detect/refine various events in a sequential manner. For example, the tracking data system may include an actor-action attention neural network system to detect/refine one or more of: shots, scores, points, rebounds, passes, dribbles, penalties, fouls, and/or possessions. The tracking data system may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, the tracking data system may generate contextual information to enhance the detected events. Exemplary contextual information may include defensive matchup information (e.g., who is guarding who at each frame, defensive formations), as well as other defensive information such as coverages for ball-screens or presses.

Processor 116 and/or data store 118 may be operated (e.g., using applicable code) to receive tracking data in a first format, store game files in a second format, and/or output game data (e.g., to predictor 126) in a third format. For example, processor 116 may receive an intended destination for game data (or data stored in data store 118 in general) and may format the data into a format acceptable by the intended destination.

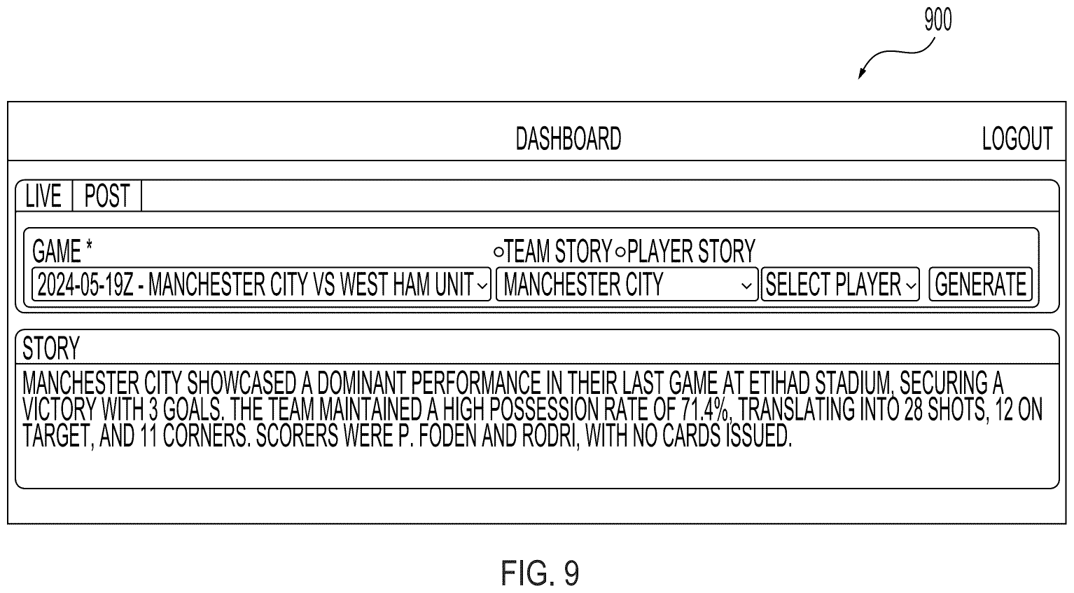

Computing system 104 may be configured to manage and analyze the data captured by tracking system 102 and/or additional data such as game data from previous games and environmental data. Examples of environmental data include venue data, referee data, and weather data. Computing system 104 may include a web client application server 114, a processor 116 (e.g., a preprocessor agent), a data store 118, predictor 126, and a third-party Application Programming Interface (API) 138. An example of computing system 104 is depicted with respect to FIG. 9. Processor 116 may be configured to process data retrieved from data store 118 or tracking system 102 prior to input to predictor 126.

Data store 118 may be configured to store different kinds of data including sports-related data. In an example, data store 118 can store raw tracking data received from tracking system 102. The data store 118 can include historical game data, which can include historical team and player data for one or more sporting events. Data store 118 may be configured to store one or more game files. Each game file may include video data of a given match (e.g., a game, a competition, a round, etc.) and/or may include tracking data generated by tracking system 102 or in response to data generated by tracking system 102. Video data may correspond to data for an ongoing match or data for a previous or historical match. For example, the video data may correspond to video frames captured by tracking system 102 (e.g., as a broadcast feed, an in-venue feed, etc.). In some aspects, the video data may correspond to broadcast data of a given match, in which case, the video data may correspond to video frames of the broadcast feed of a given match.

Predictor 126 can include one or more machine learning models 128A-N. Predictor 126 may be configured to train or retrain machine learning models 128A-N. In some cases, one or more of the machine learning models 128A-N are remotely hosted, for example on a remote server. Machine learning models 128A-N can be generative machine learning models.

In some cases, the machine learning models 128A-N require input of a prompt. As such, computing system 104 and/or predictor 126 can generate one or more prompts such that the output of the model is aligned with the request, query, or information included in the prompt. A prompt can include instructions to the model (e.g., task(s) to be performed, and style of output), data to be used (e.g., data from a particular team or a player), and/or any user preferences (e.g., style, tone, or length).

Any component of computing system 104, for example as processor 116 or predictor 126, may include or may be implemented using one or more software modules. The software modules may be collections of code or instructions stored on a non-transitory computer-readable medium (e.g., memory of computing system 104) that represent a series of machine instructions (e.g., program code) that implements one or more algorithmic operations. Such machine instructions may be the actual computer code the processor of computing system 104 interprets to implement the instructions or, alternatively, may be a higher level of coding of the instructions that is interpreted to obtain the actual computer code. In some cases, functionality implemented by the software modules may be implemented via one or more hardware components. One or more aspects of an example algorithm may be performed by the hardware components (e.g., circuitry) itself, rather as a result of the instructions.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Client device 108 may be in communication with computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with computing system 104, such as individuals who have obtained, will obtain, or may obtain a product, service, or consultation from an entity associated with computing system 104.

Client device 108 may include one more applications 109. Application 109 may be representative of a web browser that allows access to a website or a stand-alone application. Client device 108 may access application 109 to access one or more functionalities of computing system 104. Client device 108 may communicate over network 105 to request a webpage, for example, from web client application server 114 of computing system 104. For example, client device 108 may be configured to execute application 109 to access content managed by web client application server 114. The content that is displayed to client device 108 may be transmitted from web client application server 114 to client device 108, and subsequently processed by application 109 for display through a graphical user interface (GUI) of client device 108.

Client device may include display 110. Examples of display 110 include, but are not limited to, computer displays, Light Emitting Diode (LED) displays, and so forth. Output or visualizations generated by application 109 can be displayed on display 110.

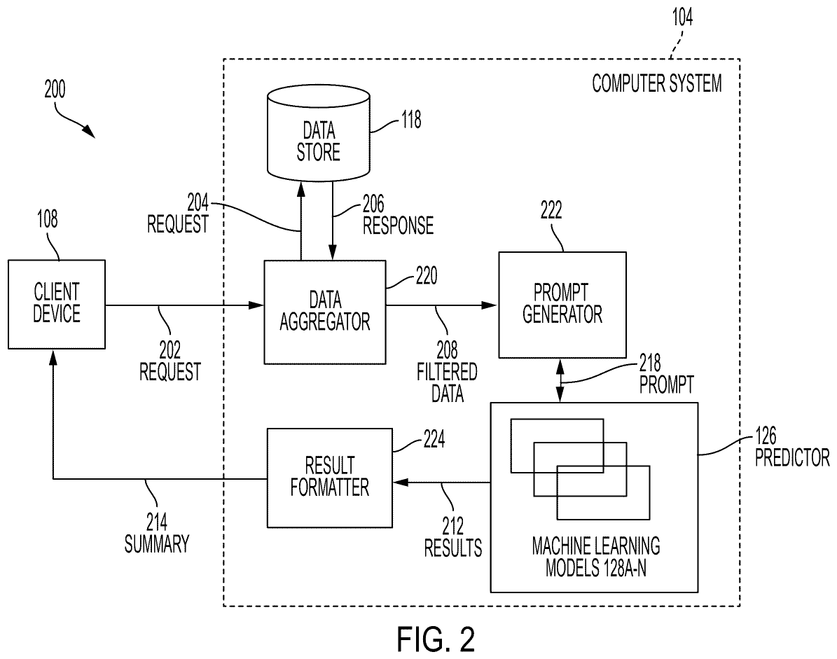

FIG. 2 is a block diagram illustrating a textual summary prediction environment 200, in accordance with an aspect of the disclosed subject matter. In the example depicted, computing system 104 generates one or more textual game summaries (summary 214) in response to requests received via client device 108. Computing system 104 includes data store 118, data aggregator 220, prompt generator 222, result formatter 224, and predictor 126. One or more of the prompt generator 222, result formatter 224, and predictor 126 may include or may communicate with one or more machine learning models, such as the generative or Large Language Models (LLMs) discussed herein.

Data store 118 can store one or more kinds of data in database records, linked lists, arrays, or other data structures. Examples of data include player tracking data as captured by tracking system 102, player ratings, excitement ratings and/or headlines, injury data, and/or environmental data. Various types of data are further discussed with respect to FIG. 3.

In some cases, data store 118 can be updated with new data (e.g., live data or updated ratings) and/or requestor preferences, as appropriate. In some cases, a secondary request 204 to the data store 118, as further discussed herein, can be in the form of a HTTP GET. In some cases, the response 206 from data store 118 can be a JSON type response.

Data aggregator 220 may receive request 202 from client device 108. A request from client device 108 can include a type of textual summary required and may provide particular teams, sports, leagues, and/or players of interest. For example, client device 108 transmits a request 202 that includes a request for a replay of the Atlanta United vs. Toronto FC soccer match that took place on Mar. 4, 2023. In some cases, the request can include optional requestor preferences, such as a desired tone, style, length, and/or format of the summary. For example, a request 202 may include specified tone of a casual type and a length of approximately 100 words. In an example, the request 202 may be received by the data aggregator 220 during user defined intervals and/or for a user defined event. For example, the data aggregator 220 may receive the request 202 from the client device 108 after one half of a soccer match. In other examples, the data aggregator 220 may receive the request 202 from the client device 108 for a specific sports league.

In some cases, the data aggregator 220 may automatically retrieve the request 202 from the client device 108. For example, the client device 108 may be associated with a user profile. In some cases, the data aggregator 220 may search a profile database associated with the client device 108 for a user profile associated with the client device 108. The user profile may include one or more user preferences associated with the particular teams, sports, leagues, and/or players of interest. For example, the one or more user preferences may indicate the user of the user profile wishes to receive all event information related to Atlanta United. This event information may include a match replay, a match report, a player report, or the like. In some examples, the one or more user preferences may be associated with a subscription service associated with the user profile.

In the example case, if the data aggregator 220 finds a user profile associated with the client device 108, the data aggregator 220 may analyze the user profile to determine whether the one or more user preferences of the user profile matches an event. The event may be a soccer match, football game, hockey game, a team sport game, an individual sport game, and/or the like. The event may have occurred in the past or may be happening live. As such, the data aggregator 220 may analyze the user profile in near real time or may analyze the user profile at a determined interval. For example, the data aggregator 220 may analyze the user profile at a determined number of seconds, minutes, hours, etc. In other examples, the data aggregator 220 may analyze the user profile during a frame of an event. For example, the data aggregator 220 may analyze the user profile at the end of a specified period of the event (e.g., end of a half, end of a quarter, etc.), after a specified action of the event (e.g., a goal is scored, a player reaches a specified milestone, a team reaches a specified milestone, etc.), or any combination of the specified period, the specified action, or the determined interval. If the data aggregator 220 determines that the one or more user preferences of the user profile matches the event (e.g., the event type, team, player, period of time during an event, etc.), then the data aggregator 220 may retrieve the request 202 from the user device 108.

Upon receipt of request 202, data aggregator 220 can process request 202 and generate a secondary request 204 to obtain data from data store 118. Secondary request 204 can be formulated or adjusted based on preferences obtained via request 202, e.g., from client device 108. Accordingly, the type of data requested in secondary request 204 can depend on the contents of request 202. For instance, secondary request 204 can include specific attributes such as sports, team names, leagues, players, and so forth. In some cases, one or more Application Programming Interfaces (APIs) 138 can be used to obtain the data from the data store 118.

According to an embodiment, data aggregator 220 may use a generative model to convert request 202 into one or more metadata items associated with one or more sporting events. The metadata items may be specific items provided in request 202 (e.g., player, team, sporting event, etc.) and/or may be items identified by the generative model to be associated with the specific items provided in request 202 (e.g., specific games, opponent information, types of event actions, types of tracking data, etc.). Accordingly, the generative model disclosed herein may be trained based on historical or simulated sport event information and may be used to generate metadata items that meet a threshold correlation value for request 202. In doing so, the generative model may exclude unrelated metadata items, allowing for faster and more efficient subsequent operations limited to the identified metadata items.

Continuing the example, data aggregator 220 formulates a secondary request 204 for game data that is relevant to the Atlanta United vs. Toronto FC soccer match. The secondary request 204 can include, for example, the metadata items that correspond to “MLS soccer,” and information regarding the match, e.g., “Atlanta United” or “Toronto FC.” Formulating secondary request 204 may include parsing the request 202 to match components of request 202 with known fixed or dynamic attributes (e.g., in the form of the metadata items). The known fixed or dynamic attributes may be stored at data aggregator 220 or may be dynamically determined by data aggregator 220 (e.g., using a generative model to parse request 202). Data aggregator 220 may further transform request 202 from a first format to a second format, where the second format may be a format applicable to data store 118. Accordingly, data aggregator 220 may generate secondary request 204 based on a format associated with data store 118 which may be different than a format associated with another data store.

In response to secondary request 204, data aggregator 220 receives relevant data from data store 118 (e.g., via response 206). Continuing the example, relevant data in this case may include a performance of each team (e.g., “Atlanta United” and/or “Toronto FC”) throughout the season, performance of particular players, odds, and so forth. In some cases, data aggregator 220 can further refine or filter the data obtained from data store 118. For instance, data store 118 may provide data that is not relevant, or may provide more data than can be provided to a machine learning model given various constraints such as bandwidth or processing time. In these cases, the obtained data may be filtered. In some cases, data aggregator 220 can process the received data and issue an additional request to data store 118 for additional data. Data aggregator 220 can pass the data, e.g., filtered data 208, to prompt generator 222.

In turn, prompt generator 222 can formulate a prompt 218 designed to obtain an accurate and appropriate preview or summary from predictor 126 or other applicable component (including machine learning models 128A-N). As discussed further herein, prompt 218 can include information such as instructions readable by one or more of machine learning models 128A-N, one or more other machine learning models, data derived from various database records obtained from data store 118 by data aggregator 220, and/or preferences received from user device 108 via request 202. As shown in FIG. 1, machine learning models 128A-N may be part of predictor 126 and may, in part, generate game previews based by predicting game events based on input data. Although machine learning models 128A-N are shown as part of predictor 126, it will be understood that, as applied herein, machine learning models 128A-N may be external to predictor 126. For example, machine learning models 128A-N may be independent of predictor 126 and may output game summaries. In such a scenario, machine learning models 128A-N may include generate models and/or LLMs to generate game summaries based on input data such as, but not limited to, tracking data or event data. For simplicity, both game summaries and game previous are discussed with respect to predictor 126 and machine learning models 128A-N herein.

Machine learning models 128A-N may include one or more generative machine learning models trained to output data and/or textual summaries based on the input data derived from various database records obtained from data store 118 by data aggregator 220 and/or preferences received from user device 108 via request 202. The one or more models may be trained using historical or simulated sports data, historical or simulated preferences, and/or the like. As further discussed herein, the one or more models may be iteratively trained based on updated (e.g., current) training data such as game data, feedback from result formatter 224, and/or a user.

Prompt generator 222 provides prompt 218 to predictor 126, which in turn passes prompt 218 to one or more of the machine learning models 128A-N. The machine learning models 128A-N output results 212. In some cases, multiple machine learning models 128A-N are used. In some cases, machine learning models 128A-N are used in an iterative manner, that is, results can be obtained and then provided back into one or more of machine learning models 128A-N for further analysis or refinement.

Prompt generator 222 may generate prompt 218 based on request 202, secondary request 204, and/or filtered data 208. For example, prompt generator 222 may transform request 202 or secondary request 204 into prompt 218 based on metadata associated with filtered data 208. For example, prompt generator may expand the parameters associated with request 202 or secondary request 204 based on metadata associated with filtered data 208. Such expansion may be based on, for example, modifying the parameters associated with request 202 or secondary request 204 based on historical or simulated prompts (e.g., from the user, from a cohort of users, etc.). For example, for a given request, prompt generator 222 may analyze the metadata associated with filtered data 208 to determine correlation scores between the metadata and historical or simulated prompts that include relevant parameters. The correlation score may be assigned to each such relevant parameters based on the correlation between the relevant parameters and the metadata associated with filtered data 208. For relevant parameters that exceed a correlation score threshold, prompt generator 222 may add such relevant parameters to the parameters associated with request 202 or secondary request 204, thereby expanding the set of parameters for generating prompt 218. Prompt 218 may include or be provided with, for example, tracking data and/or event data from tracking system 102 and/or other components. Such tracking data and/or event data may be generated in accordance with the techniques disclosed herein and may enable generative machine learning models to generate results 212 based on the prompt.

Prompt 218 may be provided to the machine learning models 128A-N of predictor 126 or other applicable component. Machine learning models 128A-N may be trained to output results 212 that may include game summaries or previews based on prompt 218 and the tracking data and/or event data included therein.

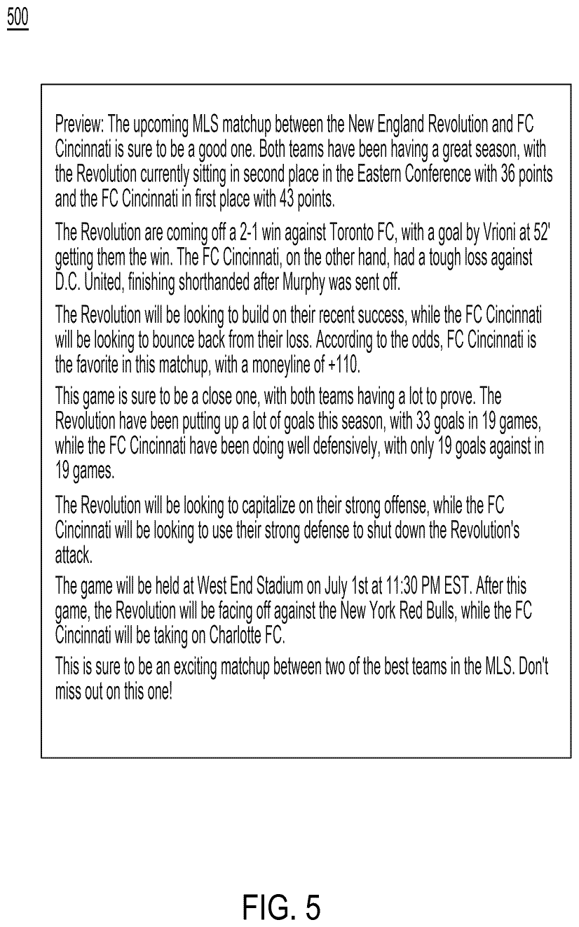

Result formatter 224 can receive results 212 from predictor 126 or other applicable component and format the results 212. Formatting requirements can include, but is not limited to, stylistic formatting, style, spelling, and grammar. Formatting requirements may be provided by the user (e.g., via request 202 or stored in a user profile). Following any formatting, result formatter 224 may generate summary 214 and provide summary 214 to the client device 108. Exemplary summaries are provided with respect to FIGS. 5-7. But summaries with other styles, formats, and so forth are possible.

FIG. 3 is a block diagram illustrating a data store 300, in accordance with an aspect of the disclosed subject matter. Data store 300 may be an example of data store 118. As depicted, data store 300 includes ratings 310, standings 320, team statistics 330, and odds 340. But additional data can also be included. Data store 300 can be stored, for example, within computing system 104, but can also be stored remotely, e.g., across network 105 on a server device. Data store 300 can be updated in real-time, for example, including updates on a game in play, updated league tables, or rankings.

Ratings 310 can include player ratings, team ratings, excitement rating, and/or other ratings. As depicted, ratings 310 includes multiple entries for various games. For instance, the entry for Game 1 includes scores, passes, and assists. But other entries are possible. Non-limiting examples include shots, goals (xG), assists (xA), crosses, total passes, total short passes (<32 m), total long passes (˜32 m), passes in attacking thirds, penalty area entries, take-downs, defensive actions in own third, defensive actions in middle third, defensive actions in opposition thirds, and so forth.

While these examples are specific to soccer, it will be appreciated, that other ratings are possible for other sports (e.g., baseball, basketball, American football, rugby, tennis, golf, cricket, hockey, team sports, individual sports, etc.). For example, in the context of baseball, relevant ratings may include batting statistics and pitching statistics. Examples of batting statistics include slugging (total number of bases reached by a hitter divided by the number of at-bats); on-base plus slugging (OPS), which refers to how often a batter gets on base and how often they get other bases. Examples of pitching statistics include innings pitched, hits, runs, and so forth.

In some cases, ratings 310 can also include excitement ratings. Non-limiting examples of excitement ratings include a measurement of interest in a particular game, player, or league and a measurement of interest in games or matches that are at particular times of day or night, at a particular point in a season, and so forth. Excitement ratings can be neutral, that is, not from a perspective of a fan of one team or another, but from a neutral observer or a non-fan. In some cases, excitement ratings can be from the perspective of a fan of a particular team. In some cases, the excitement ratings can be affected by whether a game is played at home or away.

In some cases, ratings 310 can include headline data. Headline data can include whether a player or team has made it into headlines of a print or online publication. In some cases, the headline data can be used in or referred to by the textual summary.

In some cases, ratings 310 can include injury data. Examples of injury data include injuries sustained by a current player, a current status of an injury, predicted injuries, whether an injured player is healing, how long the player may be out of commission, and so forth. For live reports, injury data can be updated in real time, for instance, if a player gets injured, then ratings 310 can include real updates about the injury.

Standings 320 includes data indicating relative standings of teams within a particular league. For example, a team could be ranked second out of forty teams. For instance, in the context of premier league soccer, the premier league standings table may be used. This table ranks each team and includes games won, drawn, lost, home and away statistics, and so forth.

Statistics 330 includes statistics about a particular team. For examine, in the context of soccer, statistics could include a number of wins, number of losses, and so forth for a particular team, etc. In baseball, statistics 330 may include a number of home runs, a number of strikes, and so forth. Statistics 330 can be aggregated player statistics, and/or linked to statistics of particular players, e.g., key players.

Odds 340 can include betting odds different teams within a league or different matchups of teams, whether hypothetical or real. Odds 340 can be based on predicted or actual performance of teams. As depicted, odds 340 includes odds for matchups between teams 1 and 2, teams 3 and 4, and teams 1 and 4.

In some aspects, additional data can be stored in data store 118. For example, data store 118 can include match data, e.g., position data. In some aspects, data store 118 can store environmental data such as venue data, referee data, and so forth.

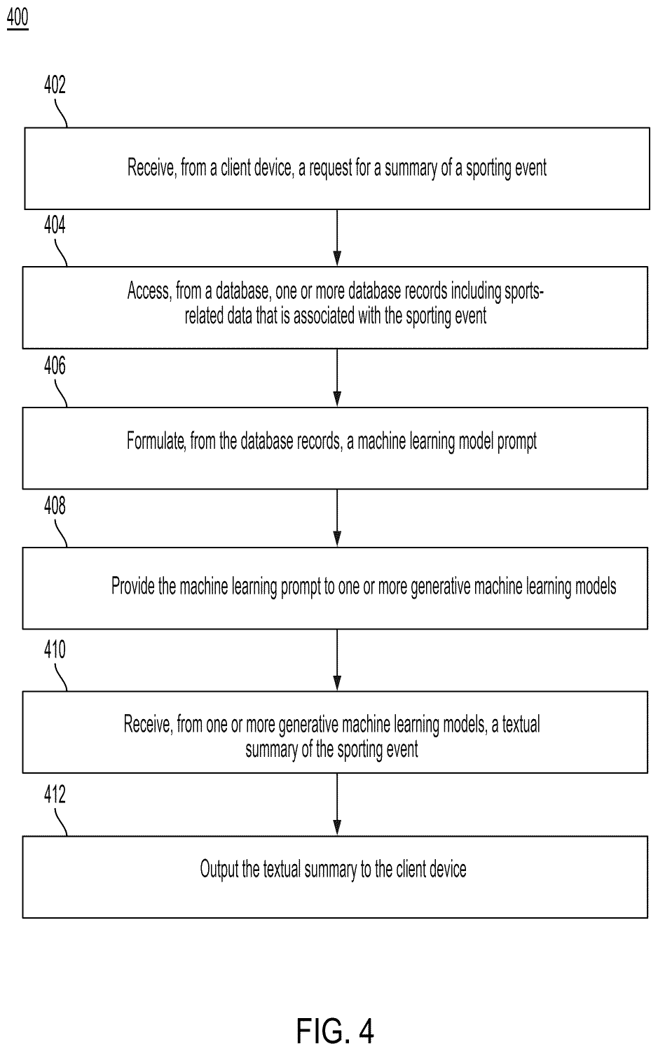

FIG. 4 is a flow diagram of an exemplary method 400 for using machine learning models to generate textual summaries of sporting events, in accordance with an aspect of the disclosed subject matter. For illustrative purposes, method 400 is discussed with respect to environment 100 of FIG. 1 and environment 200 of FIG. 2.

Method 400 includes various operations, indicated by blocks. It will be appreciated that in some cases, not all operations are performed. For example, in some cases, some operations can be skipped. In some examples, operations can be performed multiple times, for example, in a loop. Other variations are possible.

Method 400 can be used to generate game previews, game summaries, and/or live reports. As discussed, game previews can facilitate a basic understanding of a context of a game that as yet to occur, game summaries provide a more detailed summary of a completed game, and live reports are summaries of an ongoing game.

In some cases, user preferences are accommodated when generating the textual summaries. In some cases, these preferences can be aggregated into one or more profiles. For instance, a particular user may have a preference for short summaries, or a particular sentiment, or a preference for information about their favorite team only. Accordingly, in some cases, method 400 operates in the context of a set of predefined user preferences.

At block 402, method 400 may involve receiving, from a client device, a request for a summary of a sporting event. For example, client device 108 sends a request 202 for a summary of a sporting event to computing system 104. In turn, computing system 104, specifically, data aggregator 220, receives request 202. Request 202 can include a type of request (e.g., summary, preview, or live event), the relevant sport, league, one or more team names, and so forth. In some cases request 202 can include style, tone, sentiment, and so forth.

At block 404, method 400 may involve accessing, from a database, one or more database records including sports related data that is associated with the sporting event. Sports related data may include, but is not limited to, data from data store 118 and data from data store 300. Sports related data may include live or archived data. The data may be obtained from sources such as cameras, individuals monitoring a game, or other data feeds.

Continuing the example, data aggregator 220 formulates secondary request 204 and provides secondary request 204 to data store 118. In an example, the data requested includes ratings of players on a team associated with the sporting event, standing of the team relative to an associated league, and odds of a predicted performance of the team.

The data requested can differ based on the type of summary requested, specifically game previews, summaries, and live reports. For example, in the case of a live report, the requested data can be live data. The live data can include tracking data generated based on a broadcast feed of the sporting event or based on live cameras at the sporting event. The tracking data can include mathematical representations of positional information, object information, body pose information, or trend information. The data requested can include environmental data. Examples of environmental data include venue data, referee data, weather data, and so forth.

In some cases, the data format may not be compatible with a format accepted by the machine learning models 128A-N. Accordingly, in some cases, the sports related data is modified from a first format (e.g., native to the data store 118) to a second format (e.g., native to the machine learning models 128A-N). Continuing the example, data aggregator 220 provides the received data from response 206 to prompt generator 222 as filtered data 208.

At block 406, method 400 may involve formulating from the database records, a machine learning model prompt. The prompt can include one or more of instructions, data, and preferences. Instructions can include preferences for one or more of a task, topic, style, tone, or format of the summary. Such preferences, which can be received from client device 108 via request 202, are added to the prompt prior to providing the prompt to the one or more generative machine learning models. As discussed with respect to block 404, data can be obtained from data store 118 and optionally filtered for relevancy.

Examples of possible instruction include a task, topic, style, tone, audience, and length. In some cases, the prompt includes a style. Examples of styles include casual, formal, business, etc. In some cases, the styles can include personality names such as Jane Austen or Jeremy Clarkson. In some cases, the prompt includes a tone. Examples of tones are happy, sad, optimistic, and ecstatic. In some cases, the prompt includes a specified output format. Examples are text, HTML, XML, and so forth. In some cases, the prompt can include a requested language such as English or Spanish.

Prompts can be provided in natural language format. For example, in the context of textual summaries, therefore, a simplified example of a prompt might include “summarize the current match between Arsenal and Liverpool” or “summarize the current match using only the included data.” Continuing the example, prompt generator 222 generates a prompt 218. The machine learning model prompt can include instructions readable by machine learning models 128a-n and/or sports related data from the one or more database records.

At block 408, method 400 may involve providing the machine learning model prompt to the one or more generative machine learning models. Continuing the example, prompt generator 222 provides prompt 218 to predictor 126, including one or more of machine learning models 128A-N. As discussed, machine learning models 128A-N can be generative machine learning models.

At block 410, method 400 may involve receiving, from the one or more generative machine learning models, a textual summary of the sporting event. Continuing the example, in turn, result formatter 224 receives, from the machine learning models 128A-N, summary 214. As discussed with respect to FIG. 3, the summary 214 may be edited, formatted, or otherwise updated or altered before being output as summary 214. Examples of textual summaries are provided with respect to FIGS. 5, 6, and 7. The summary 214 may be additionally edited, formatted, or otherwise updated or altered to reduce the length of the summary 214, translate the summary 214, and/or format the summary 214.

At block 412, method 400 may involve transmitting the textual summary to the client device 108. The textual summary may Continuing the example, the summary 214 is provided to client device 108.

FIG. 5 is an exemplary textual preview 500, in accordance with an aspect of the disclosed subject matter. Game previews can facilitate a basic understanding of a context of a game that has yet to occur.

As depicted, textual preview 500 previews an upcoming MLS game between New England Revolution and FC Cincinnati. Preview 500 include recent successes and losses and makes some game predictions.

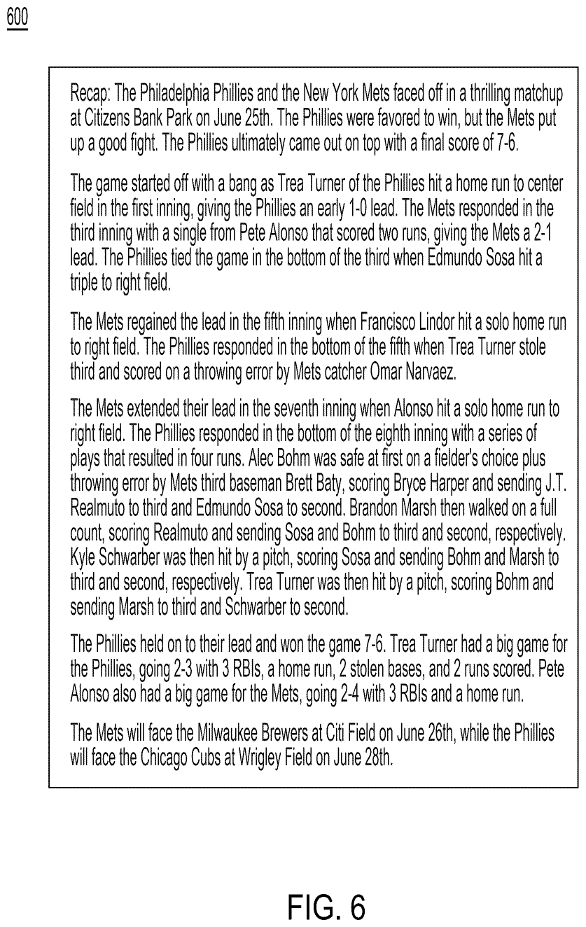

FIG. 6 is an exemplary textual summary 600, in accordance with an aspect of the disclosed subject matter. Game summaries provide a more detailed summary of a completed game, including in some cases, headlines and player ratings. As depicted, textual summary 600 summarizes a recent game between the Philadelphia Phillies and the New York Mets and lists the final score. Then, the textual summary 600 starts from the beginning of the game, recalling major events during the game, and ends by providing the reader with information regarding the Mets' next game.

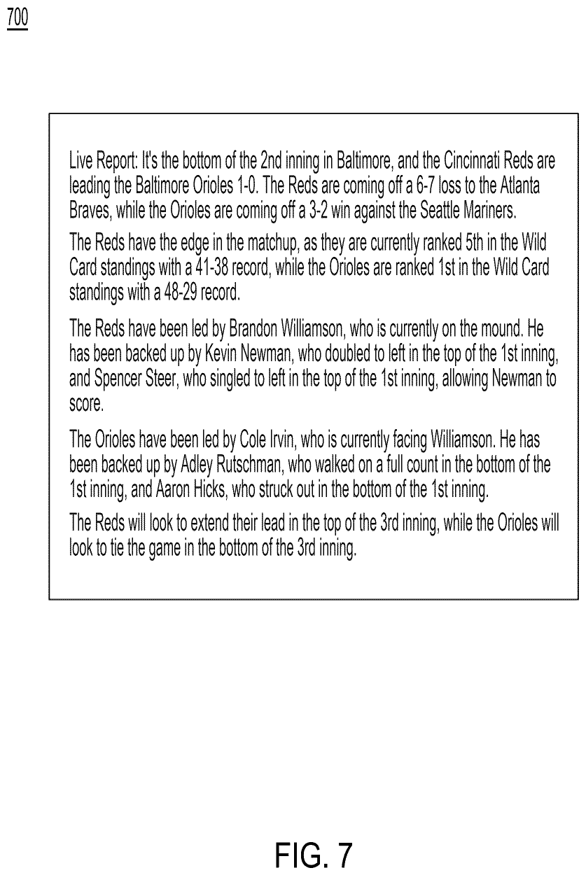

FIG. 7 is an exemplary textual live report 700, in accordance with an aspect of the disclosed subject matter. Live reports are summaries of an ongoing game, and can include updates on scores, fouls, players, injuries, and so forth.

As depicted, textual report 700 starts with a summary of the current inning in the game between the Cincinnati Reds and the Baltimore Orioles. The live summary continues with some key ranking statistics and key players and ends with a prediction of each team's longer-term goals.

According to certain aspects, user preferences (e.g., determined based on a user profile) may be used to augment a request 202, secondary request 204, and/or a prompt to a machine learning model. For example, a user's textual summary preference may be obtained from a user profile, which may be iteratively updated based on new requests 202. The user preferences may automatically augment a user a request 202, secondary request 204, and/or a prompt to a machine learning model without additional user input.

As previously discussed, request 202 may automatically be generated based on a user profile. For example, a request machine learning model may be trained based on historical user requests and may automatically generate request 202 based on a trigger event associated with the historical user requests. Such a trigger may correspond to a user location (e.g., provided via a Geographical Positioning System (GPS) sensor of user device 108), a sporting event (e.g., a sporting event associated with a user's preferred team), an excitement level associated with a sporting event, and/or the like.

User device 108 may detect a trigger event (e.g., via a request machine learning model) and may automatically generate request 202 based on the trigger event. The request machine learning model may analyze the generated request 202 to determine a data point necessary for generation of a textual summary based on the generated request 202 and/or filtering of data for generation of the textual summary. In an example, the request machine learning model may determine that the data point necessary for generation of the textual summary includes player tracking data or event data. For example, the request machine learning model may determine that an excitement rating is necessary for generation of the textual summary. In such an example, the request machine learning model may update the request 202 to include an excitement rating in order to generate the textual summary. In other examples, the request machine learning model may update the request 202 such that the textual summary is generated based solely on the excitement rating. As used herein, an excitement rating may be determined by, for example, analyzing audio signals associated with a sporting event feed. The excitement ratings for each of a plurality of subsets of a sporting event feed may correspond to the volume, pitch, or other audio attributes associated with that subset of the sporting event feed. Accordingly, a game summary may be generated based on events (e.g., subsets of sporting events) associated with a threshold excitement rating, while excluding events that have an excitement rating below the excitement rating threshold. For brevity, only one data point is described, but it is contemplated that other data points such as player positioning, team, sport, play type, player statistics, team statistics, or the like may be used in generation and/or filtering of the textual summary. The processes discussed herein may be initiated in response to the request 202 in a manner similar to if request 202 was generated based on user input. According to these aspects, user input may not be required or may supplement the automatically generated request 202. According to aspects, the textual summary (e.g., as shown in FIG. 5, FIG. 6, and FIG. 7) may be populated based on user preferences. In such aspects, the order of information provided via the textual summary, visual attributes (e.g., font, color, size, etc.) associated with such summaries, information included in such summaries, and/or the like may be determined based on user preferences. As discussed herein, such user preferences may be received from a user profile which may be iteratively updated based on new requests 202, user interaction with a past textual summary, user affinities determined based on a user's consumption of sports data and/or video streams, and/or the like. In an example, the information provided in the textual summary may be filtered based on the user preferences. For example, the filtering based on the user preferences may be: particular to a specific sport, based on an event in the match, based on the type of query received, etc. In such an example, the filtered information may be provided in the training of a machine learning model and/or during updating of a machine learning model.

In an example, the textual summary may be translated to voice via API 138 or a text-to-speech synthesizer. For example, the textual summary may be output by the machine learning model as a textual summary and then further translated into speech. The translated speech summary may be output using an audio output device associated or in communication with client device 108 (e.g., speakers, headphones, etc.).

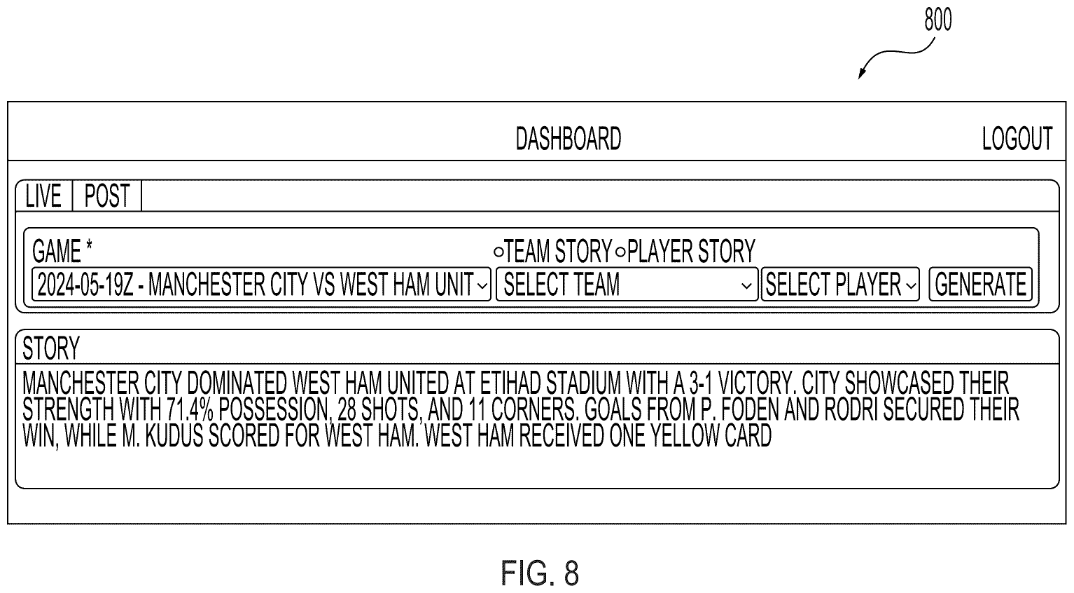

FIG. 8 is an exemplary textual summary 800, in accordance with an aspect of the disclosed subject matter. Game summaries provide a more detailed summary of a completed game, including in some cases, headlines and player ratings. As depicted, textual summary 800 summarizes a recent game between Manchester City and West Ham United and details the final score while recalling major events during the game. The textual summary 800 may be presented in a GUI.

FIG. 9 is an exemplary textual summary 900, in accordance with an aspect of the disclosed subject matter. Team summaries provide a more detailed summary of a specific team in a completed game, including in some cases, headlines and player ratings. As depicted, textual summary 900 summarizes a recent performance of Manchester City and details the goal tally of the team while recalling major statistics of the game and performances of major contributors for the team. The textual summary 900 may be presented in a GUI.

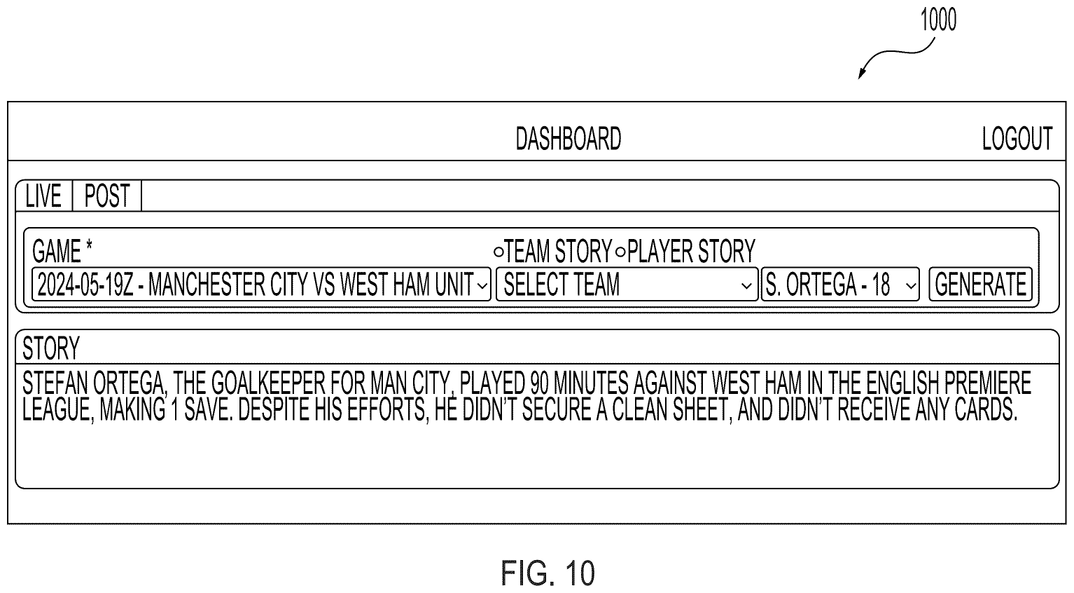

FIG. 10 is an exemplary textual summary 1000, in accordance with an aspect of the disclosed subject matter. Player summaries provide a more detailed summary of a specific player in a completed game, including in some cases, headlines and player ratings. As depicted, textual summary 1000 summarizes a recent performance for Stefan Ortega of Manchester City. The textual summary 1000 details the performance of the player during a game. The textual summary 1000 may be presented in a GUI.

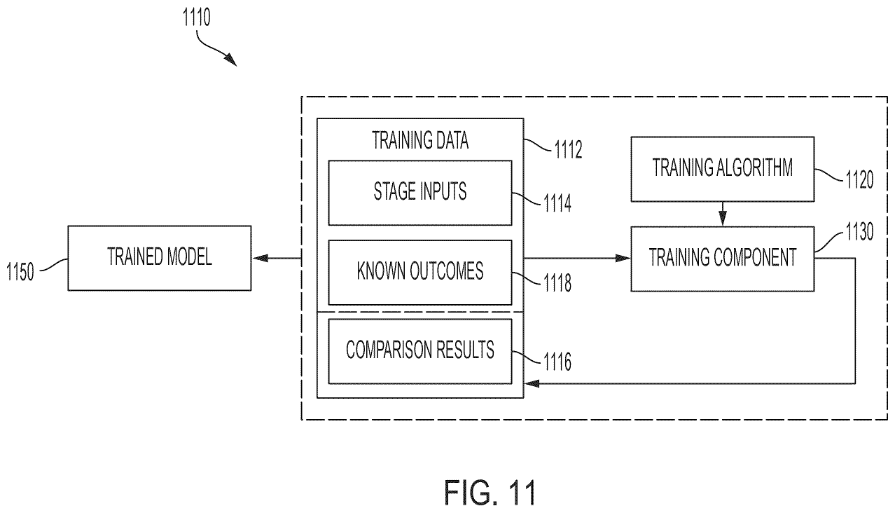

FIG. 11 depicts a flow diagram for training a machine learning model, in accordance with an aspect of the disclosed subject matter. As shown in flow diagram 1110 of FIG. 11, training data 1112 may include one or more of stage inputs 1114 and known outcomes 1118 related to a machine learning model to be trained. The stage inputs 1114 may be from any applicable source including a component or set shown in the figures provided herein. The known outcomes 1118 may be included for machine learning models generated based on supervised or semi-supervised training. An unsupervised machine learning model might not be trained using known outcomes 1118. Known outcomes 1118 may include known or desired outputs for future inputs similar to or in the same category as stage inputs 1114 that do not have corresponding known outputs.

The training data 1112 and a training algorithm 1120 may be provided to a training component 1130 that may apply the training data 1112 to the training algorithm 1120 to generate a trained machine learning model 1150. According to an implementation, the training component 1130 may be provided comparison results 1116 that compare a previous output of the corresponding machine learning model to apply the previous result to re-train the machine learning model. The comparison results 1116 may be used by the training component 1130 to update the corresponding machine learning model. The training algorithm 1120 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1110 may be a trained machine learning model 1150.

In an example, the machine learning model may receive, as inputs, a first data set and a second data set. Additionally, tracking data and event data may be provided as inputs to the machine learning model or may be otherwise accessible by the machine learning model. A computing system may generate the event data by, for example, analyzing the tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). The machine learning model learns associations between the first data set and the second data set. Based on such input data and/or access, the machine learning model may output the output data and/or textual summaries.

In an example, the machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training.

Once trained, the machine learning model may output machine learning model outputs in accordance with the subject matter disclosed herein. According to an implementation, one or more machine learning models disclosed herein may continuously update based on feedback associated with use or implementation of the machine learning model outputs.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

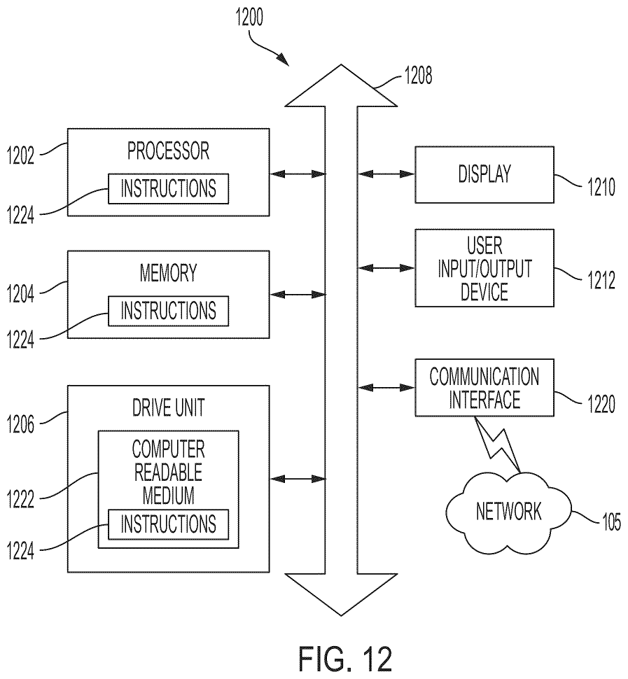

FIG. 12 is a simplified functional block diagram of a computer 1200 that may be configured as a device for executing the methods disclosed here, according to exemplary aspects of the present disclosure. For example, the computer 1200 may be configured as a system according to exemplary aspects of this disclosure. In various aspects, any of the systems herein may be a computer 1200 including, for example, a data communication interface 1220 for packet data communication. The computer 1200 also may include a central processing unit (“CPU”) 1202, in the form of one or more processors, for executing program instructions. The computer 1200 may include an internal communication bus 1208, and a storage unit 1206 (such as ROM, HDD, SDD, etc.) that may store data on a computer readable medium 1222, although the computer 1200 may receive programming and data via network communications.

The computer 1200 may also have a memory 1204 (such as RAM) storing instructions 1224 for executing techniques presented herein, for example the methods described with respect to FIGS. 4 and 11, although the instructions 1224 may be stored temporarily or permanently within other modules of computer 1200 (e.g., processor 1202 and/or computer readable medium 1222). The computer 1200 also may include input and output ports 1212 and/or a display 1210 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating textual summaries using one or more generative machine learning models, the method comprising:
receiving, from a client device, a request for a summary of a sporting event;
accessing, from a database, one or more database records comprising sports related data that is associated with the sporting event;
formulating, from the database records, a machine learning model prompt, wherein the machine learning model prompt comprises (i) instructions readable by the one or more generative machine learning models and (ii) sports related data from the one or more database records;
providing the machine learning model prompt to the one or more generative machine learning models;
receiving, from the one or more generative machine learning models, a textual summary of the sporting event; and
outputting the textual summary to the client device.

2. The method of claim 1, wherein the sports related data comprises tracking data generated based on a broadcast feed of the sporting event.

3. The method of claim 2, wherein the tracking data comprises mathematical representations of one or more of positional information, object information, body pose information, or trend information.

4. The method of claim 1, wherein the instructions comprise preferences for a sentiment of the summary and wherein the textual summary aligns with the sentiment received from the client device.

5. The method of claim 1, wherein the database records comprise ratings of players on a team associated with the sporting event, standing of the team relative to an associated league, and odds of a predicted performance of the team.

6. The method of claim 1, wherein the instructions comprise preferences for one or more of a task, topic, style, tone, or format of the summary, the method further comprising, adding the preferences to the prompt prior to providing the prompt to the one or more generative machine learning models.

7. The method of claim 1, wherein the summary is one or more of a preview of a future sporting event, a recap of a past sporting event, and a live report of an ongoing sporting event.

8. The method of claim 1, further comprising:
identifying, in the database, one or more preferences associated with a user of the client device; and
filtering the one or more database records according to the preferences.

9. The method of claim 1, further comprising:
receiving, from the database, one or more updated database records comprising live data from the sporting event;
formulating, from the updated database records, an updated machine learning model prompt;
applying the one or more machine learning models to the updated machine learning model prompt;
receiving, from the one or more machine learning models, an updated textual summary of the sporting event; and
outputting the updated textual summary to the client device.

10. A system for generating textual summaries using one or more generative machine learning models, the system comprising:
a non-transitory computer readable medium configured to store processor-readable instructions; and
a processor operatively connected to the non-transitory computer readable medium, and configured to execute the instructions to perform operations comprising:
receiving, from a client device, a request for a summary of a sporting event;
accessing, from a database, one or more database records comprising sports related data that is associated with the sporting event;
formulating, from the database records, a machine learning model prompt, wherein the machine learning model prompt comprises (i) instructions readable by the one or more generative machine learning models and (ii) sports related data from the one or more database records;
providing the machine learning model prompt to the one or more generative machine learning models;
receiving, from the one or more generative machine learning models, a textual summary of the sporting event; and
outputting the textual summary to the client device.

11. The system of claim 10, wherein the sports related data comprises tracking data generated based on a broadcast feed of the sporting event.

12. The system of claim 11, wherein the tracking data comprises mathematical representations of one or more of positional information, object information, body pose information, or trend information.

13. The system of claim 10, wherein the instructions comprise preferences for a sentiment of the summary and wherein the textual summary aligns with the sentiment received from the client device.

14. The system of claim 10, wherein the database records comprise ratings of players on a team associated with the sporting event, standing of the team relative to an associated league, and odds of a predicted performance of the team.

15. The system of claim 10, wherein the instructions comprise preferences for one or more of a task, topic, style, tone, or format of the summary, the operations further comprising, adding the preferences to the prompt prior to providing the prompt to the one or more generative machine learning models.

16. The system of claim 10, wherein the summary is one or more of a preview of a future sporting event, a recap of a past sporting event, and a live report of an ongoing sporting event.

17. The system of claim 10, the operations further comprising:
identifying, in the database, one or more preferences associated with a user of the client device; and
filtering the one or more database records according to the preferences.

18. The system of claim 10, the operations further comprising:
receiving, from the database, one or more updated database records comprising live data from the sporting event;
formulating, from the updated database records, an updated machine learning model prompt;
applying the one or more machine learning models to the updated machine learning model prompt;
receiving, from the one or more machine learning models, an updated textual summary of the sporting event; and
outputting the updated textual summary to the client device.

19. A non-transitory computer readable medium configured to store processor-readable instructions, wherein when executed by a processor, the instructions perform operations comprising:
receiving, from a client device, a request for a summary of a sporting event;
accessing, from a database, one or more database records comprising sports related data that is associated with the sporting event;
formulating, from the database records, a machine learning model prompt, wherein the machine learning model prompt comprises (i) instructions readable by one or more generative machine learning models and (ii) sports related data from the one or more database records;
providing the machine learning model prompt to the one or more generative machine learning models;
receiving, from the one or more generative machine learning models, a textual summary of the sporting event; and
outputting the textual summary to the client device.

20. The non-transitory computer readable medium of claim 19, wherein the sports related data comprises tracking data generated based on a broadcast feed of the sporting event.
